(19) United States
(12) Patent Application Publication
(10) Pub. No.: US 2011/0075654 A1
(43) Pub. Date: Mar. 31, 2011

(54) Method and System for Implementing Redundancy at Signaling Gateway Using Dynamic SIGTRAN Architecture

(75) Inventors: Damascene Joachimpillai, Westford, MA (US); Gareth Cooper, Swindon (GB); Vikram Siwach, Cambridge, MA (US); Christopher L. Dischino, Tewksbury, MA (US)

(73) Assignee: Sonus Networks, Inc., Westford, MA (US)

(21) Appl. No.: 12/569,523

(22) Filed: Sep. 29, 2009

(51) Int. Cl. H04L 12/66

(52) U.S. Cl. 370/352

(57) ABSTRACT

Described are a method, a computer program product and apparatus for implementing signaling gateway redundancy. A first SIGTRAN protocol application server process maintenance message is received, at a first signaling gateway, from a first application server process. Connection control information associated with one or more connections to the first signaling gateway is updated based on the first SIGTRAN protocol application server process maintenance message. A second SIGTRAN protocol application server process maintenance message is transmitted, from the first signaling gateway, to a second signaling gateway. The second SIGTRAN protocol application server process maintenance message is based on the first SIGTRAN protocol application server process maintenance message. The second signaling gateway is mated with the first signaling gateway.

### FIELD OF THE INVENTION

The present technology relates generally to a computer-implemented method, a computer program product and an apparatus for implementing signaling gateway redundancy.

### BACKGROUND

A traditional Public Switched Telephone Network (PSTN) typically utilizes the Signaling System #7 (SS7) messaging protocol stack to establish, manage and terminate telephone calls, as well as to provide enhanced telephone functionality such as number translation and short message services (SMS). The SS7 protocol stack includes, in part, the following suite of protocols: Message Transfer Part (MTP), Signaling Connection Control Part (SCCP), Telephone User Part (TUP), Integrated Services Digital Network (ISDN) User Part (ISUP), Transaction Capabilities Application Part (TCAP), Mobile Application Part (MAP), and Intelligent Network Application Part (INAP). TCAP, MAP and INAP can be viewed as users of SCCP services. MTP, in turn, includes MTP Level 1 (MTP1) for data link level services, MTP Level 2 (MTP2) for link level services, and MTP Level 3 (MTP3) for network level services.

Recently, the Internet and other Internet Protocol (IP)-based networks have increasingly been used to carry voice traffic traditionally carried by the PSTN. Voice Over Internet Protocol (VOIP) is the general term used to refer to the family of transmission technologies and protocols for delivery of voice communications over IP-based networks. Early implementations of VOIP faced several limitations, including low voice quality, variable packet delay, and lack of standard protocols for connection setup and/or management of telephone calls.

In order to address these early limitations of VOIP, the Internet Engineering Task Force (IETF) drafted a family of protocols that standardized certain aspects of VOIP. The IETF model includes, in part, the Session Initiation Protocol (SIP), the Signaling Transport Protocol (SIGTRAN), the Real-Time Transport Protocol (RTP), and the Media Gateway Control Protocol (MGCP). The SIGTRAN protocol is specifically directed for transporting SS7 messages over IP-based networks and includes, in part, the following suite of protocols: Stream Control Transmission Protocol (SCTP), ISDN User Adaption (IUA), MTP2 User Peer-to-Peer Adaptation Layer (M2PA), MTP2 User Adaption Layer (M2UA), MTP3 User Adaption Layer (M3UA), and SCCP User Adaptation (SUA). The SIGTRAN protocol also defines signaling gateway (SG) and signaling gateway process (SGP) network elements, which are responsible for receiving and/or sending signaling between an IP-based network and an SS7 network.

### SUMMARY OF THE INVENTION

An important aspect of any telecommunications network, especially those used to provide telephony services, is redundancy for fault tolerance purposes. For example, a signaling gateway can include mated signaling gateway processes for redundancy purposes. Conventional redundancy implementations at a signaling gateway are typically based on proprietary messaging schemes. Such proprietary messaging schemes update protocol states across co-located redundant computing elements in a signaling gateway. Finite state machines and data structures are subsequently synched across redundant computing elements to represent the most recent network state. Synching algorithms typically achieve synchronization across redundant computing elements based on recent updates, protocol states and/or related timer events. Redundant systems designed for updating and synching protocols are typically tied together with non-standard messaging, implementation specific queues and associated timers.

As with any loosely-coupled systems, there are issues related to race conditions and buffer management in failure scenarios. Conventional redundancy schemes thus introduce source code complexity and inefficient system resource utilization. Embodiments of the invention described below offer a new, standardized, scalable and optimized approach towards achieving redundancy at a signaling gateway by utilizing SIGTRAN architecture capabilities.

One approach to implement signaling gateway redundancy is to use the dynamic SIGTRAN architecture. The invention, in one aspect, includes a computer-implemented method for implementing signaling gateway redundancy. The computer-implemented method includes receiving, at a first signaling gateway host, a first signaling network management message from a first signaling network. The computer-implemented method also includes updating routing control information associated with the first signaling gateway host based on the first signaling network management message. The computer-implemented method also includes transmitting, from the first signaling gateway host, a first Signaling Transport (SIGTRAN) protocol signaling network management message to a first application server host on a first Internet Protocol (IP) network. The first SIGTRAN protocol signaling network management message is based on the first signaling network management message. The computer-implemented method also includes transmitting, from the first signaling gateway host, a second SIGTRAN protocol signaling network management message to a second signaling gateway host on a second IP network. The second SIGTRAN protocol signaling network management message is based on the first signaling network management message. The second signaling gateway host is mated with the first signaling gateway host.

In another aspect, there is a computer program product, tangibly embodied in a machine-readable storage device. The computer program product includes instructions being operable to cause a data processing apparatus to receive, at a first signaling gateway host, a first signaling network management message from a first signaling network, and update routing control information associated with the first signaling gateway host based on the first signaling network management message. The computer program product further includes instructions being operable to cause a data processing apparatus to transmit, from the first signaling gateway host, a first Signaling Transport (SIGTRAN) protocol signaling network management message to a first application server host on a first Internet Protocol (IP) network. The first SIGTRAN protocol signaling network management message is based on the first signaling network management message. The computer program product further includes instructions being operable to cause a data processing apparatus to transmit, from the first signaling gateway host, a second SIGTRAN protocol signaling network management message to a second signaling gateway host on a second IP network. The second SIGTRAN protocol signaling network management message is based on the first signaling network management message. The second signaling gateway host is mated with the first signaling gateway host.

In another aspect, there is a system for implementing signaling gateway redundancy. The system includes a controller configured to receive, at a first signaling gateway host, a first signaling network management message from a first signaling network, and update routing control information associated with the first signaling gateway host based on the first signaling network management message. The controller is further configured to transmit, from the first signaling gateway host, a first Signaling Transport (SIGTRAN) protocol signaling network management message to a first application server host on a first Internet Protocol (IP) network. The first SIGTRAN protocol signaling network management message is based on the first signaling network management message. The controller is further configured to transmit, from the first signaling gateway host, a second SIGTRAN protocol signaling network management message to a second signaling gateway host on a second IP network. The second SIGTRAN protocol signaling network management message is based on the first signaling network management message. The second signaling gateway host is mated with the first signaling gateway host.

In yet another aspect, there is a system for implementing signaling gateway redundancy. The system includes means for receiving, at a first signaling gateway host, a first signaling network management message from a first signaling network, and means for updating routing control information associated with the first signaling gateway host based on the first signaling network management message. The system further includes means for transmitting, from the first signaling gateway host, a first Signaling Transport (SIGTRAN) protocol signaling network management message to a first application server host on a first Internet Protocol (IP) network. The first SIGTRAN protocol signaling network management message is based on the first signaling network management message. The system further includes means for transmitting, from the first signaling gateway host, a second SIGTRAN protocol signaling network management message to a second signaling gateway host on a second IP network. The second SIGTRAN protocol signaling network management message is based on the first signaling network management message. The second signaling gateway host is mated with the first signaling gateway host.

In other examples, any of the aspects above can include one or more of the following features. In some embodiments, the first signaling network includes a SS7 network. The first signaling network management message can include a SS7 Signaling Network Management (SSNM) message. The SSNM message can include a Destination Unavailable (DUNA) message, a Destination Available (DAVA) message, a Signaling Congestion (SCON) message, a Destination User Part Unavailable (DUPU) message, a Destination Restricted (DRST) message, or any combination thereof. The first IP network can be the same as the second IP network. The first and second SIGTRAN signaling network management messages can be based on a MTP3 User Adaption (M3UA) protocol, a SCCP User Adaption (SUA) protocol, or any combination thereof. The second SIGTRAN protocol signaling network management message can be transmitted to the second signaling gateway host using a SGP-ASP SCTP association between the first and second signaling gateway hosts. The routing control information can include state information for one or more point codes on the first signaling network. The one or more point codes on the first signaling network can be associated with one or more Signal Transfer Points (STPs), one or more Service Switching Points (SSPs), or any combination thereof. The routing control information can include state information for one or more subsystems on the first signaling network.

In some embodiments, the method further includes receiving, at the first signaling gateway host, a third SIGTRAN protocol signaling network management message from the second signaling gateway host, and updating the routing control information associated with the first signaling gateway host based on the third SIGTRAN protocol signaling network management message. The first SIGTRAN protocol signaling network management message can include information copied from the first signaling network management message. the second SIGTRAN protocol signaling network management message comprises information copied from the first signaling network management message. The routing control information associated with the first signaling gateway host can include state information for one or more signaling end points in the first signaling network. The state information for the one or more signaling end points can be grouped by one or more SS7 point codes.

In another aspect, there is a computer-implemented method for implementing signaling gateway redundancy. The computer-implemented method includes receiving, at a first signaling gateway host, a first Signaling Transport (SIGTRAN) protocol application server process maintenance message from a first application server process. The computer-implemented method also includes updating connection control information associated with one or more connections to the first signaling gateway host based on the first SIGTRAN protocol application server process maintenance message. The computer-implemented method also includes transmitting, from the first signaling gateway host, a second SIGTRAN protocol application server process maintenance message to a second signaling gateway host. The second SIGTRAN protocol application server process maintenance message is based on the first SIGTRAN protocol application server process maintenance message. The second signaling gateway host is mated with the first signaling gateway host.

In another aspect, there is a computer program product, tangibly embodied in a machine-readable storage device. The computer program product includes instructions being operable to cause a data processing apparatus to receive, at a first signaling gateway host, a first Signaling Transport (SIGTRAN) protocol application server process maintenance message from a first application server process, and update connection control information associated with one or more connections to the first signaling gateway host based on the first SIGTRAN protocol application server process maintenance message. The computer program product further includes instructions being operable to cause a data processing apparatus to transmit, from the first signaling gateway host, a second SIGTRAN protocol application server process maintenance message to a second signaling gateway host. The second SIGTRAN protocol application server process maintenance message is based on the first SIGTRAN protocol application server process maintenance message. The second signaling gateway host is mated with the first signaling gateway host.

In another aspect, there is a system for implementing signaling gateway redundancy. The system includes a controller configured to receive, at a first signaling gateway host, a first Signaling Transport (SIGTRAN) protocol application server process maintenance message from a first application server process, and update connection control information associated with one or more connections to the first signaling gateway host based on the first SIGTRAN protocol application server process maintenance message. The controller is further configured to transmit, from the first signaling gateway host, a second SIGTRAN protocol application server process maintenance message to a second signaling gateway host. The second SIGTRAN protocol application server process maintenance message is based on the first SIGTRAN protocol application server process maintenance message. The second signaling gateway host is mated with the first signaling gateway host.

In yet another aspect, there is a system for implementing signaling gateway redundancy. The system includes means for receiving, at a first signaling gateway host, a first Signaling Transport (SIGTRAN) protocol application server process maintenance message from a first application server process, and means for updating connection control information associated with one or more connections to the first signaling gateway host based on the first SIGTRAN protocol application server process maintenance message. The system further includes means for transmitting, from the first signaling gateway host, a second SIGTRAN protocol application server process maintenance message to a second signaling gateway host. The second SIGTRAN protocol application server process maintenance message is based on the first SIGTRAN protocol application server process maintenance message. The second signaling gateway host is mated with the first signaling gateway host.

In other examples, any of the aspects above can include one or more of the following features. In some embodiments, the first SIGTRAN protocol application server process maintenance message includes an Application Server Process Traffic Maintenance (ASPTM) message. The ASPTM message can include an ASP Active (ASPAC) message, a ASP Inactive (ASPIA) message, or any combination thereof. The first SIGTRAN protocol application server process maintenance message can include an Application Server Process State Maintenance (ASPSM) message. The ASPSM message can include an ASP Up (ASPUP) message, a ASP Down (ASPDN) message, a Heartbeat (BEAT) message, or any combination thereof. The first SIGTRAN protocol application server process maintenance message can include a Routing Key Management (RKM) message. The RKM message can include a Registration Request (REG REQ) message, a Deregistration Request (DEREG REQ) message, or any combination thereof. The first and second SIGTRAN protocol application server process maintenance messages can be based on a MTP3 User Adaption (M3UA) protocol, a SCCP User Adaption (SUA) protocol, or any combination thereof. The second SIGTRAN protocol application server process maintenance messages can be transmitted to the second signaling gateway host using a ASP-SGP SCTP association between the first and second signaling gateway hosts. The connection control information can include state information for one or more application servers and/or one or more application server processes. The computer-implemented method can further include receiving, at the first signaling gateway host, a third SIGTRAN protocol application server process maintenance message from the second signaling gateway host, and updating the connection control information associated with the first signaling gateway host based on the third SIGTRAN protocol application server process maintenance message.

In some embodiments, the method further includes determining whether a state of an SCTP association between the first signaling gateway host and the first application server process has changed. If it is determined that the state of the SCTP association has changed, then connection control information associated with the SCTP association can be updated based on the change in the state of the SCTP association. A third SIGTRAN protocol application server process maintenance message can also be transmitted, from the first signaling gateway host, to the second signaling gateway host. The third SIGTRAN protocol application server process maintenance message can be based on the change in the state of the SCTP association. The state of the SCTP association can include an up state, a down state, a congestion state, or any combination thereof. The connection control information can include state information for one or more signaling end points on an Internet Protocol (IP) network. The state information for the one or more signaling end points can be grouped by application server identifiers, application server process identifiers, or any combination thereof.

Any of the above implementations can realize one or more of the following advantages. A redundant signaling gateway can advantageously allow a signaling gateway to continue to provide a common view of the signaling network to the IP-based SEP and/or of the IP-based SEP to the SEP on the signaling network, thereby keeping signaling endpoints from each network communicating with each other. In addition, the synchronization of states can advantageously help in traffic control during controlled routing of inbound traffic in case of internal association, ASP failure and/or recovery. Use of the SIGTRAN's modular architecture to synchronize mated signaling gateway processes advantageously provides reliability and redundancy to internal IP networks, because the SIGTRAN protocol suite allows dynamic and flexible network configurations by offering many-to-many relationships between ASPs, SGPs, ASs, and/or SGs. Multiple ASPs or SGPs can serve, respectively, a single AS or SG and vice versa. The above implementations advantageously utilize ASP-SGP relationships defined by standards to handle all possible connectivity and partial outage failure scenarios such as, for example, IP-based application instance (ASP/AS) outages, internal association failure, external association/links failure, and remote destination accessibility. In addition, SIGTRAN architecture implementations for redundancy purposes can require less source code complexity and allow for more efficient system resource utilization than conventional redundancy schemes. The SIGTRAN architecture implementations for redundancy purposes can also offer a new, standardized, scalable and optimized approach towards achieving redundancy at a signaling gateway.

Other aspects, examples, and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other features and advantages of the present invention, as well as the invention itself, will be more fully understood from the following description of various embodiments, when read together with the accompanying drawings.

FIG. 1 is a block diagram showing an exemplary network with devices relating to the SIGTRAN architecture, according to an illustrative embodiment of the invention.

FIG. 2 is a flowchart depicting an implementation of signaling gateway redundancy for signaling network management messages, according to an illustrative embodiment of the invention.

FIG. 3 is a flowchart depicting an implementation of signaling gateway redundancy for application server process maintenance messages, according to an illustrative embodiment of the invention.

FIG. 4 is a block diagram showing an exemplary protocol stack implementation for M3UA, according to an illustrative embodiment of the invention.

FIG. 5 is a block diagram showing an exemplary protocol stack implementation for SUA, according to an illustrative embodiment of the invention.

FIG. 6 illustrates a ladder diagram depicting CIC registration for a particular application server process, according to an illustrative embodiment of the invention.

FIG. 7 illustrates a ladder diagram depicting scenarios for the transfer of signaling data from a M3UA client to a signaling network, according to an illustrative embodiment of the invention.

FIG. 8 illustrates a ladder diagram depicting scenarios for the transfer of signaling data from a signaling network to a M3UA client, according to an illustrative embodiment of the invention.

FIG. 9 illustrates a ladder diagram depicting the processing of DUNA and DAVA SSNM messages, according to an illustrative embodiment of the invention.

FIG. 10 illustrates a ladder diagram depicting the processing of SCON SSNM messages, according to an illustrative embodiment of the invention.

FIG. 11 illustrates a ladder diagram depicting processing of DUPU SSNM messages, according to an illustrative embodiment of the invention.

FIG. 12 illustrates a ladder diagram depicting processing of DRST SSNM messages, according to an illustrative embodiment of the invention.

FIG. 13 illustrates a ladder diagram depicting SCTP failure on an IP network, according to an illustrative embodiment of the invention.

### DETAILED DESCRIPTION

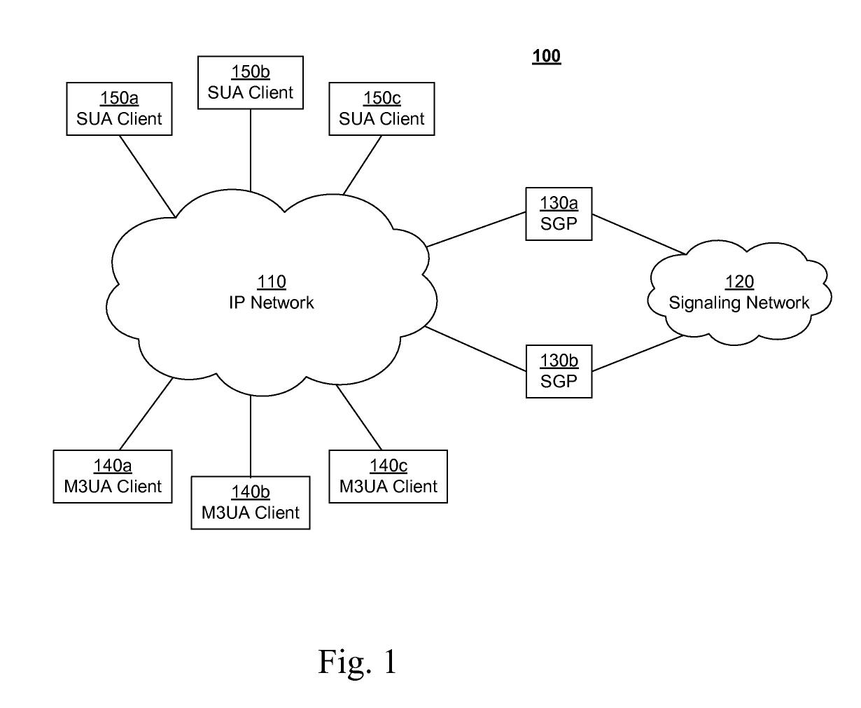

FIG. 1 is a block diagram showing an exemplary network 100 with devices relating to the SIGTRAN architecture, according to an illustrative embodiment of the invention. The network 100 includes an IP network 110, a signaling network 120, one or more signaling gateway processes (SGPs) 130a and/or 130b, generally 130, one or more M3UA clients 140a, 140b, and/or 140c, generally 140, and one or more SUA clients 150a, 150b, and/or 150c, generally 150.

The IP network 110 is responsible for the transfer of information between one or more of the SGPs 130, one or more of the M3UA clients 140, and/or one or more of the SUA clients 150. Information transfer over the IP network 110 is based at least, in part, on the Internet Protocol (IP), but can be based on one or more additional communication protocols such as, for example, Asynchronous Transfer Mode (ATM), Ethernet, and/or any other link or network layer protocol. The IP network 110 can include one or more packet-based networks in any configuration. Packet-based networks can include, for example, the Internet, a carrier Internet Protocol (IP) network (LAN, WAN, or the like), a private IP network, an IP private branch exchange (IPBX), a wireless network (e.g., a Radio Access Network (RAN)), and/or other packet-based networks.

The signaling network 120 is responsible for the transfer of SS7 messages between one or more signaling end points (SEPs) (not shown). In some embodiments, the SGPs 130 are connected to one or more Signaling Transfer Points (STPs) (not shown) in the signaling network 120. In some embodiments, the signaling network 120 includes and/or is based, in part, on the Internet Protocol. For example, one or more STPs, or other SS7 network element, in the signaling network 120 can exchange information with a SGP 130 using M3UA, M2PA, and/or other SIGTRAN protocols.

With respect to the M3UA and SUA clients 140 and 150, the SIGTRAN protocol architecture identifies two types of nodes: signaling gateways (SGs) and application servers (ASs). Generally, signaling gateways can perform functions related to signaling conversion between nodes located in a SS7 network and nodes located in an IP-based network. For example, signaling gateways can convert MTP3 messages into M3UA messages and forward the M3UA message to the appropriate IP-based Signaling End Point (SEP). Similarly, signaling gateways can convert SCCP messages into SUA messages and forward the SUA message to the appropriate IP-based SEP. Application servers, in general, can perform functions related to signaling applications located in an IP-based network. For example, application servers can perform MGC, SCP and/or HLR functions. For routing purposes, application servers can serve a specific routing key. For example, a routing key can be associated with all calls associated with a unique range of PSTN trunks, identified by SS7 service identifier octet (SIO), destination point code (DPC), origination point code (OPC), circuit identification code (CIC) range, and/or other SS7 identifiers. In some embodiments, an application server serves a particular SS7 Point Code partially or completely. In alternative or supplemental embodiments, a routing key is also associated with, in part, one or more subsystem numbers and/or a TCAP identifier.

The SIGTRAN protocol also identifies two types of processes: signaling gateway processes (SGPs) and application server processes (ASPs). Signaling gateway processes and application server processes are process instances that can implement, respectively, the functionality of a signaling gateway and an application server. A signaling gateway process and/or an application server process can contain an SCTP end-point and can be configured, respectively, to process signaling traffic within more than one application server or signaling gateway.

Signaling gateways, in turn, can include one or more signaling gateway processes. For example, taken together, SGPs 130a and 130b can be a single signaling gateway. Signaling gateway processes can be classified as being in an active state, a standby state, a load-sharing traffic state, a broadcast state, and/or other SGP state. Likewise, an application server can include one or more application server processes. For example, M3UA clients 140a, 140b, and 140c can each be a specific application server process that defines a single application server for M3UA services Likewise, SUA clients 150a, 150b, and 150c can each be a specific application server process that defines a single application server for SUA services. Application server processes can be classified as being in an active state, a standby state, and/or other ASP state. Application servers can be classified as being in an up state, a down state, and/or other AS state.

In some embodiments, signaling gateways and/or application servers are physical computing devices such as, for example, one or more computer processors and/or other integrated circuits housed in one or more computer system hosts. In supplemental or alternative embodiments, signaling gateways and/or application servers are logical entities such as, for example, one or more software processes distributed over one or more physical computing devices. For example, SGPs 130a and 130b can define a single signaling gateway distributed over two different computer system hosts. In some embodiments, signaling gateway processes and application server processes are one or more computer processors and/or other integrated circuits housed in one or more computer system hosts.

For purposes of interworking between the IP-based network 110 and the signaling network 120, one or more signaling gateway processes, such as SGPs 130a and 130b, within a signaling gateway can actively handle the data traffic towards a particular application server. Each signaling gateway process can maintain the status of the application server and the application server processes within the application server. Based on the routing key and the maintained status information, signaling gateway processes can appropriately route incoming data from a signaling network to an application server by selecting an application server process serving the application server.

In some embodiments, signaling gateway applications are deployed as a co-located pair in order to achieve a level of redundancy to guard against potential connectivity failure and/or partial outages. A redundant signaling gateway can advantageously allow the signaling gateway to continue to provide a common view of the signaling network to the IP-based SEP and/or of the IP-based SEP to the SEP on the signaling network, thereby keeping signaling endpoints on each network communicating to each other. For example, SGPs 130a and 130b can be mated SGPs. In some embodiments, SGPs 130a and 130b exchange information with each other using the IP network 110. In alternative or supplemental embodiments, SGPs 130a and 130b exchange information with each other using a separate IP network (not shown) from the IP network 110. For example, SGPs 130a and 130b can exchange information with each other using a dedicated communication link.

The M3UA clients 140 can be signaling end points for MTP3 services. In general, the M3UA protocol can advantageously extend the reach of SS7 into an IP network by providing an MTP3 service to an M3UA client. In some embodiments, the M3UA clients 140 are ISUP users such as, for example, Media Gateway Controllers (MGCs). In these cases, the SGPs 130 can relay call setup and management messages between the M3UA clients 140 and the appropriate SEP(s) in the signaling network 120.

The SUA clients 150 can be signaling end points for SCCP services. Like M3UA, the SUA protocol can advantageously extend the reach of SS7 into an IP network by providing a SCCP service to a SUA client. In some embodiments, the SUA clients 150 are TCAP users such as, for example, Service Control Points (SCPs). In alternative or supplemental embodiments, the SUA clients 150 are MAP users such as, for example, Home Location Registers (HLR).

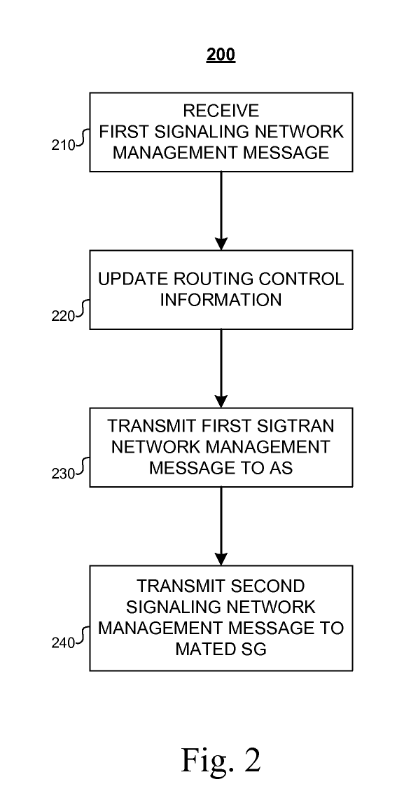

FIG. 2 illustrates a flowchart 200 depicting an implementation of signaling gateway redundancy for signaling network management messages, according to an illustrative embodiment of the invention. The elements of flowchart 200 are described using the exemplary network 100 of FIG. 1. However, the method of FIG. 2 can be implemented with alternative network structures/configurations not so limited by FIG. 1. For example, alternative networks can include more or fewer network elements as depicted in FIG. 1. The implementation includes receiving a first signaling network management message from the signaling network 120 (210), updating routing control information associated with the first signaling gateway host based on the first signaling network management message (220), transmitting a first SIGTRAN protocol signaling network management message to a first application server host on a first IP network (230), and/or transmitting a second SIGTRAN protocol signaling network management message to a second signaling gateway host on a second IP network (240).

A first signaling network management message can be received from the signaling network 120 (210) at, for example, a SGP 130 located on a particular host. In general, a signaling network management message can include information on the status of one or more network elements in the signaling network 120. In some embodiments, the first signaling network management message includes a SS7 Signaling Network Management (SSNM) message. SSNM messages can include, in part, a Destination Unavailable (DUNA) message, a Destination Available (DAVA) message, a Signaling Congestion (SCON) message, a Destination User Part Unavailable (DUPU) message, a Destination Restricted (DRST) message, other SSNM messages, or any combination thereof. DUNA and DAVA messages can, respectively, represent that one or more DPCs that have become inaccessible or accessible. SCON messages can represent that there is a congestion in the SS7 network to one or more destinations. DUPU messages can represent that a remote peer MTP3 user part at an SS7 node is unavailable. DRST messages can represent that one or more destinations that are restricted from the point of view of the signaling gateway.

Generally, SGPs 130 maintain state information of one or more network elements in the signaling network 120. For example, a SGP 130 can maintain state information on whether one or more SEPs in the signaling network 120 are available to receive messages. In other examples, a SGP 130 can maintain state information on the congestion status of one or more signaling links and/or SEPs in the signaling network 120. SGPs 130 can more efficiently relay signaling messages between the signaling network 120 and the IP network 110 based on such routing control information. The SGPs 130 can use signaling network management messages received from the signaling network 120 to update its internal routing control information (220). For example, if a DUNA message is received for a particular SEP, then the SGP 130 can update the routing control information associated with that particular SEP such that the SGP 130 knows not to send any messages to the SEP until its status is updated. The routing control information can be stored in a computer-readable storage device accessible by the SGP 130.

In some embodiments, the routing control information includes state information for one or more point codes on the signaling network 120. The one or more point codes on the signaling network 120 can be associated with one or more Signal Transfer Points (STPs), one or more Service Switching Points (SSPs), or any combination thereof. In alternative or supplemental embodiments, the control information includes state information associated with one or more subsystems on the signaling network 120.

In some embodiments, a SGP 130 converts a received signaling network management message into a SIGTRAN protocol signaling network management message and transmit it to an application server host on the IP network 110 (230). For example, a received SSNM message can be converted into a M3UA or SUA SIGTRAN protocol message and transmitted, respectively, to the appropriate M3UA client 140 or SUA client 150. The M3UA client that is sent the SIGTRAN protocol signaling network management message can be an application server that is registered for relevant routing control information.

With respect to redundancy, a signaling gateway process (e.g., SGP 130a) can synchronize inbound signaling network management messages received from the signaling network 120 network with its mated SGP (e.g., SGP 130b) so as to advantageously provide a consistent view of the point code accessibility via both SGP computing elements. Synchronization can be performed, for example, by SGP 130a transmitting a second SIGTRAN protocol signaling network management message to a mated signaling gateway host (e.g., SGP 130b) (240), where the second SIGTRAN protocol signaling network management message includes information associated with the received signaling network management message. In some embodiments, the SIGTRAN protocol signaling network management message sent to the mated signaling gateway process includes the same state information as the SIGTRAN protocol signaling network management message forwarded to the application server process. Upon receipt of synchronized SIGTRAN protocol messages from its mated SGP, a SGP 130 can update its internal routing control information based on the received SIGTRAN protocol signaling network management message.

Use of the SIGTRAN architecture's decomposed nature to synchronize mated signaling gateway processes can advantageously provide reliability and redundancy to internal IP networks. In some embodiments, the redundancy amongst mated signaling gateway processes is achieved via ASP-SGP association pairs as described below. The SIGTRAN signaling network management messages can be based on a M3UA protocol, a SUA protocol, or any combination thereof.

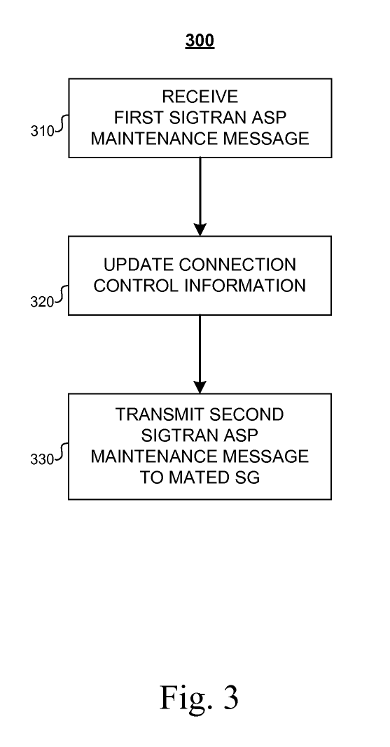

FIG. 3 illustrates a flowchart 300 depicting an implementation of signaling gateway redundancy for application server process maintenance messages, according to an illustrative embodiment of the invention. The elements of flowchart 300 are described using the exemplary network 100 of FIG. 1. However, the method of FIG. 3 can be implemented with alternative network structures/configurations not so limited by FIG. 1. For example, alternative networks can include more or fewer network elements as depicted in FIG. 1. The implementation includes receiving a first SIGTRAN protocol application server process maintenance message from a first application server process (310), updating connection control information associated with one or more connections to the first signaling gateway host based on the first SIGTRAN protocol application server process maintenance message (320), and/or transmitting a second SIGTRAN protocol application server process maintenance message to a second signaling gateway host (330).

A first SIGTRAN protocol application server process maintenance message can be received (310) from a first application server process located at, for example, a M3UA client 140 or a SUA client 150. In general, a SIGTRAN protocol application server process maintenance message can include status and/or maintenance information for one or more network elements in the IP network 110. In some embodiments, the first SIGTRAN protocol application server process maintenance message includes an Application Server Process Traffic Maintenance (ASPTM) message. ASPTM messages can include an ASP Active (ASPAC) message, an ASP Inactive (ASPIA) message, or any combination thereof. ASPAC messages can be used to notify remote peers that an application server process is ready to process signaling traffic for a particular application server. ASPIA messages can be used to notify remote peers that an application server process is no longer an active application server process to be used from within a list of application server processes.

In some embodiments, the first SIGTRAN protocol application server process maintenance message includes an Application Server Process State Maintenance (ASPSM) message. ASPSM messages can include an ASP Up (ASPUP) message, an ASP Down (ASPDN) message, a Heartbeat (BEAT) message, or any combination thereof. ASPUP messages can be used to represent to a remote peer that the adaptation layer is ready to receive any ASPSM and/or ASPTM messages for all routing keys that the application server process is configured to serve. ASPDN messages can be used to represent to a remote peer that the adaptation layer is not ready to receive one or more types of messages. For example, ASPDN can be used to represent that the adaptation layer is not ready to receive DATA, SSNM, RKM, or ASPTM messages. BEAT messages can be used to ensure that an IUA peer is still available.

In some embodiments, the first SIGTRAN protocol application server process maintenance message includes a Routing Key Management (RKM) message. RKM messages can include a Registration Request (REG REQ) message, a Deregistration Request (DEREG REQ) message, or any combination thereof. REG REQ messages can be used by an application server process to represent to a remote peer that it wishes to register one or more given routing keys with the remote peer. DEREG REQ messages can be used by an application server process to represent to a remote peer that it wishes to deregister a given routing key.

Generally, SGPs 130 maintain state information of one or more network elements in the IP network 110. For example, a SGP 130 can maintain state information on whether one or more application server processes on a M3UA client 140 or a SUA client 150 are registered, active/inactive, up/down, what their associated routing keys are, current SCTP association status (up, down, congested, etc.), and/or other state information. Based on such connection control information, SGPs 130 can more efficiently relay signaling messages between the signaling network 120 and the IP network 110. The SGPs 130 can use SIGTRAN protocol application server process maintenance messages received from the IP network 110 to updating their internal connection control information (320). For example, if an ASPIA message is received for a particular application server process, then the SGP 130 can update the connection control information associated with that particular application server process such that the SGP 130 knows not to send certain messages to the application server process until its status is updated. The connection control information can be stored in a computer-readable storage device accessible by the SGP 130.

With respect to redundancy, a signaling gateway process (e.g., SGP 130a) can synchronize SIGTRAN protocol application server process maintenance messages received from the IP network 110 network with its mated SGP (e.g., SGP 130b) so as to advantageously provide a consistent view of application server and application server processes via both SGP computing elements. Synchronization can be performed, for example, by SGP 130a transmitting a second SIGTRAN protocol application server process maintenance message to a mated signaling gateway host (e.g., SGP 130b) (330), where the second SIGTRAN protocol application server process maintenance message includes information associated with the received SIGTRAN protocol application server process maintenance message. In some embodiments, the SIGTRAN protocol application server process maintenance message sent to the mated signaling gateway process includes the same state information as the SIGTRAN protocol application server process maintenance message received from the IP network 110. Upon receipt of synchronized SIGTRAN protocol messages from its mated SGP, a SGP 130 can update its internal connection control information based on the received SIGTRAN protocol application server process maintenance message.

In some embodiments, the redundancy amongst mated signaling gateway process pair(s) is achieved via ASP-SGP association pairs as described below. The SIGTRAN protocol application server process maintenance messages can be based on a M3UA protocol, a SUA protocol, or any combination thereof.

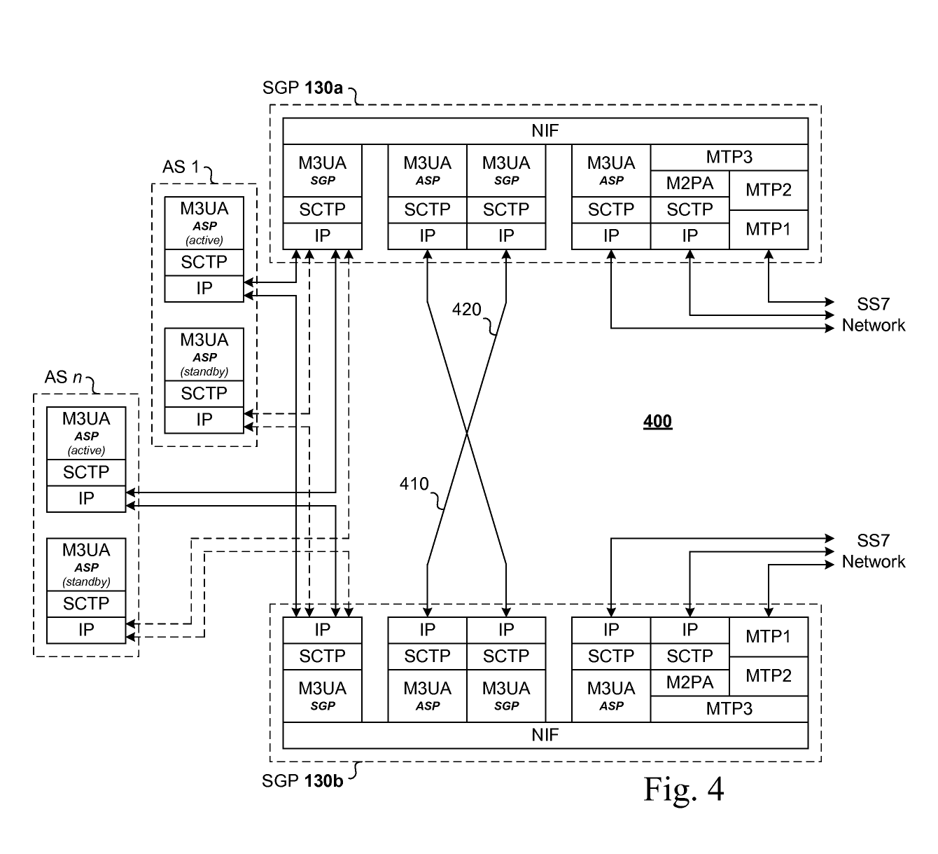

FIG. 4 is a block diagram 400 showing an exemplary protocol stack implementation for M3UA, according to an illustrative embodiment of the invention. SGP 130a and 130b can each have connectivity with both the IP-based network 110 and the signaling network 120 in order to relay M3UA messages from one network to other and perform M3UA interworking functions as needed. Specifically, each SGP 130a and 130b can include one or more M3UA stack instances for communicating with SEPs on the IP-based network 110 and/or the signaling network 120, and with their respective mated SGP pair(s). A SGP 130 can communicate with the signaling network 120 via a traditional MTP stack (e.g., using MTP2 and MTP1), a MTP3/M2PA hybrid stack, a M3UA stack, and/or other stacks.

A SGP 130 can communicate with an IP-based SEP via a M3UA SGP stack instance. IP-based SEPs can include, for example, a M3UA client 140 running one or more application server processes. In diagram 400, the signaling gateway that includes SGPs 130a and 130b can service one or more application servers (e.g., AS 1 through AS n), which, in turn, can include one or more application server processes. While FIG. 4 illustrates that each AS includes two application server processes, with one application server process in an active state and the other application server process in a standby state, other configurations can also be used. Within this distributed system, multiple application server processes can setup SCTP association with each SGP 130 and can activate message transfer at these associations using ASPSM and/or ASPTM messages. After respective SCTP associations have been setup, the signaling gateway can equally load share data messages for a particular application server among the currently active application server processes. From the application server process point of view, a SS7 destination can be accessible via more than one SGP.

The redundancy between the mated SGPs 130a and 130b can be achieved via indirect ASP-SGP stack instances with respective SCTP associations 410 and 420, which are established using the M3UA and SCTP protocols. Each SGP 130 that initiates a M3UA association can take the role of the ASP. Similarly, each SGP 130 that listens and accepts the association can take the role of the SGP. The ASP to SGP associations 410 and 420 from either side can simulate the direct path from an application end point (ASP to SGP) within the IP-based network 110. Subsequent exchange of ASPSM, RKM and/or ASPTM messages within the IP-based network 110 can trigger the same exchange from indirect ASP to SGP associations 410 and 420 across the mated computing element (CE) pair of SGPs 130a and 130b. Multiple application servers serving multiple routing keys can be normalized over single inter-CE association by utilizing multiple routing contexts identifying each signaling data range associated within the direct application server. Normalization of multiple routing keys refers to usage of multiple routing contexts to represent the routing data served by each of the application servers in the IP-based network. These application servers can connect to SGP over one or more SCTP associations. The inter-CE association is capable of sending and/or receiving all the data associated with multiple application servers by using a different routing context with data associated with each of the application servers.

Therefore, changes in the states of direct application server processes in an application server (e.g., based on the exchange of defined ASPSM, ASPTM messages and/or the state of SCTP association) can change corresponding accessibility states within the inter-CE from indirect ASP to SGP associations. The synchronization of states can advantageously help in traffic control during controlled routing of inbound traffic in case of internal association, ASP failure and/or recovery.

The SGP to ASP associations 410 and 420 from either side can also simulate the direct path from SGP to ASP (i.e., the SGP-ASP association between a SGP 130 and an ASP on a M3UA client 140) by exchanging, with the mated SGP, external destination accessibility from SSNM messages received from the signaling network 120. The SGP-ASP associations can also keep the network status table in synch at the NIF layer for controlled routing of outbound traffic during partial external network connectivity. Traffic data can be optimally routed based on route accessibility via mated SGPs during a partial failure scenarios. External networks can also utilize path level redundancy via one or more associations across the mated SGPs.

The inter-CE path (also referred to as the indirect path) can be utilized for load balancing towards the SS7 network and/or message distribution when the current SGP 130 is isolated from the application server process and/or the SS7 network. As illustrated in diagram 400, the inter-CE resources of SGPs 130a and 130b can be separated by a stack instance from the SS7 Network and application server process resources in the direct path stack, which can allow the NIF to have additional flexibility when routing data and/or SSNM messages.

The redundancy model described above can advantageously synchronize the internal and external network protocol states and continue to normalize a unified view to the SS7 and internal endpoints within co-located SG applications. The model can advantageously utilize ASP-SGP relationships defined by standards to handle all possible connectivity and partial outage failure scenarios such as, for example, IP-based application instance (ASP/AS) outages, internal association failure, external association/links failure, and remote destination accessibility.

To provide for interworking functionality, each SGP 130 includes a M3UA Nodal Interworking Function (NIF) layer. The NIF layer can manage point code accessibility state to the signaling network 120. Each of the SGPs 130a and 130b can have different accessibility status for the same point code. Each of the SGPs 130a and 130b can also normalize the destination accessibility to present a unified local view and can inform the accessibility status of each point code to all application server processes with the help of SSNM messages.

With respect to connection control, the NIF layer can maintain a table and/or list of specific application server processes that serve a particular application, which can be used to route messages to a particular application server process. Such connection control information can be configured statically and/or dynamically. For example, dynamic configuration can be performed using RKM messages. The connection control information can also change based on the state(s) of one or more application server processes in an application server. States of application server process in an application server can be changed based on, for example, the exchange of defined ASPSM and ASPTM messages and/or the change in state of SCTP associations between the SGPs 130 and the application server processes. With respect to routing control, the NIF layer can maintain a table and/or list that includes the status (or general state information) for each of the endpoints it can route to. Such routing control information can be configured dynamically using SSNM messages.

Each NIF layer in a SGP 130 can process in an Active/Active mode, whereas other parts of the system can run in an Active/Standby mode, such as configuration management and/or event logging. Within the NIF layer, certain code paths can determine a primary SGP (e.g., SGP 130a) verses a secondary SGP (e.g., SGP 130b). Whenever the NIF needs to determine the current SGP's role, a configuration management interface can be provided. If the configuration status is active, then the SGP role returned is as primary CE, but if the configuration status is standby then the SGP role returned is as secondary CE.

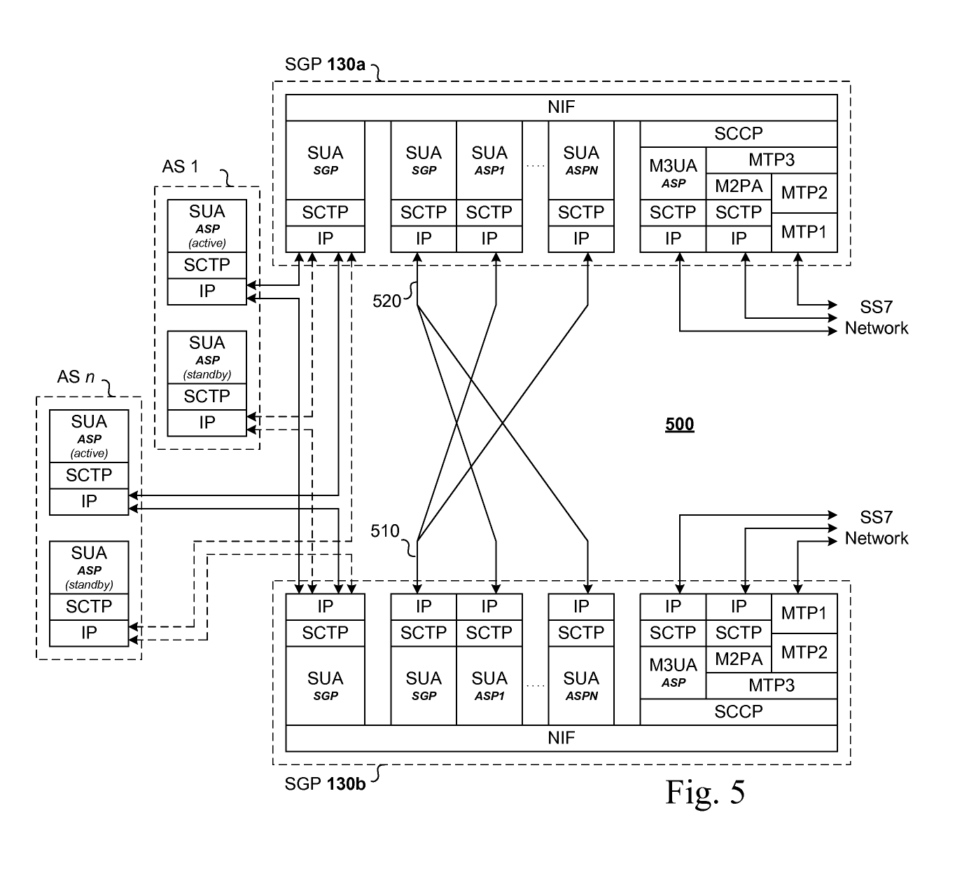

FIG. 5 is a block diagram 500 showing an exemplary protocol stack implementation for SUA, according to an illustrative embodiment of the invention, which can operate on a SGP 130 in conjunction with the stack implementation of FIG. 4. Each SGP 130a and 130b can have connectivity with both the IP-based network 110 and the signaling network 120 in order to relay SUA messages from one network to other and perform SUA interworking functions as needed. Specifically, each SGP 130a and 130b can include one or more SUA stack instances for communicating with SEPs on the IP-based network 110 and/or the signaling network 120, and with their respective mated SGP pair(s). An IP-based SEP can include, for example, a SUA client 150 running one or more application server processes. A SGP 130 can communicate with an IP-based SEP via a SUA SGP stack instance. IP-based SEPs can include, for example, a SUA client 150 running one or more application server processes.

Like the M3UA implementation illustrated in FIG. 4, within this distributed system multiple application server processes can setup SCTP association(s) with each SGP 130 and can activate message transfer at these associations using ASPSM and/or ASPTM messages. After respective SCTP associations have been setup, the signaling gateway can equally load share data messages for a particular application server among the currently active application server processes. In some embodiments, the application server processes in the SUA diagram 500 are deployed as active elements. Similarly, each SGP 130 can activate message transfer using SSNM messages for inbound scenarios.

To provide for interworking functionality, each SGP 130 includes a SUA Nodal Interworking Function (NIF) layer. The SUA NIF can manage protocol translation of inbound signaling messages, including connectionless data and all SSNM messages from SCCP protocol format to SUA protocol format, and protocol translation of outbound signaling messages, including connectionless data from SUA to SCCP and inbound/outbound SCCP Global Title Address Translations. Connectionless data traffic can include, for example, TCAP transactions. SCCP can allow for a distinction among the various applications within a network node and can refer to these applications as subsystems. Therefore, SCCP can include its own subsystem management functions.

The two systems can be maintained in an active load share model using the redundant pair of inter-CE SGPs 130a and 130b. The view to the client (IP-based network) side can be normalized at the NIF layer. Similarly, the view to the SS7 network side can also be normalized at the NIF layer. The NIF layer employs a SUA ASP/SGP relationship between the two systems to achieve the SS7 connectivity view to the IP-based SUA clients 150 and the client connectivity view to the SS7 network.

In contrast with the M3UA model of FIG. 4, the routing key involved in serving the SUA application server processes can include one or more M3UA routing key elements and a TCAP Transactions ID Range (TID label). For example, a list of SUA ASPs can serve a particular network variant (TCAP AS), where a TCAP application server is configured to support call processing for multiple ranges of TCAP users that are represented by SCCP SSN values. A SUA ASP can register with a SGP 130 to receive TCAP messages for the Subsystems at a remote Point Code(s) of IN/AIN network elements and databases. SUA ASPs can serve an application server in a load share traffic mode to support the a distributed architecture. At the SGP 130 node, a list of SUA ASPs that serve a particular application server can be configured statically and/or dynamically. Dynamic configuration can be done using RKM messages.

Multiple SUA ASP stack instances can serve the same logical application, which can be similar to a distributed system being served by multiple ASPs. Each SUA ASP can establish a SCTP association with each SGP 130 and can activate message transfer at these associations using ASPSM and ASPTM messages. After this, a SGP 130 can equally load share messages for the particular application server among the currently active SUA ASPs.

The state information for sub-system accessibility to the network can be managed by the NIF. In such a manner, the SGPs 130a and 130b can synchronize inbound SSNM messages across the mated pair so as to provide a consistent view of the point code and/or sub-system number accessibility via both SGP computing elements 130a and 130b.

The redundancy amongst the mated SGPs 130a and 130b can be achieved via indirect ASP-SGP stack instances with respective SCTP associations 510 and 520, which are established using the SUA and SCTP protocols. Each SGP 130 that initiates a SUA association can take the role of the ASP. Similarly, each SGP 130 that listens and accepts the association can take the role of the SGP. The ASP to SGP associations 510 and 520 from either side can simulate the direct path from an application end point (ASP to SGP) within the IP-based network 110. Subsequent exchange of ASPSM, RKM and/or ASPTM messages within the IP-based network 110 can trigger the same exchange from indirect ASP to SGP associations 510 and 520 across the mated computing elements (CEs) of SGPs 130a and 130b. Multiple application servers serving multiple routing keys can be normalized over a single inter-CE association by utilizing multiple routing context identifying each signaling data range associated within a direct application server.

The SGP to ASP associations 510 and 520 from either side can also simulate the direct path from SGP to ASP (i.e., the SGP-ASP association between a SGP 130 and an ASP on a M3UA client 140) by exchanging, with the mated SGP, external destination accessibility from SSNM messages received from the signaling network 120. The SGP-ASP associations can also keep the network status table in synch at the NIF layer for controlled routing of outbound traffic during partial external network connectivity. Traffic data can be optimally routed based on route accessibility via mated SGPs during a partial failure scenarios. External networks can also utilize path level redundancy via one or more associations across the mated SGPs.

When the routing key (within SUA destination address) that is registered towards the signaling gateway includes PC and SSN, then SUA ASP Active can also define a TID label associated with each SUA ASP such that all TCAP transactions originated by the SUA ASP bear the TID label. Multiple indirect ASPs to SGP relationships 510 and 520 need to be defined for each direct ASP to SGP relationship existing (i.e., indirect SUA ASP1-SUA ASPN to SUA SGP relationships correspond to ASs 1 to N). In particular, the inter-CE ASP directed towards a mate SGP can simulate all SUA ASPs and corresponding TID range accessibility/inaccessibility for better traffic management by configuring multiple application servers within ASP, and each application server serving a unique TID label associated with a particular SUA ASP. The application server shall be provisioned via a static TID label registration mode offered by the SUA stack on a state change for SUA ASP. Similarly, the inter-CE SGP directed towards mate SGP can simulate the mated STP pair from the signaling network 120 and, as consequence, can exchange SSNM messages regarding PC/SSN accessibility towards the inter-CE ASP of the SGP mate.

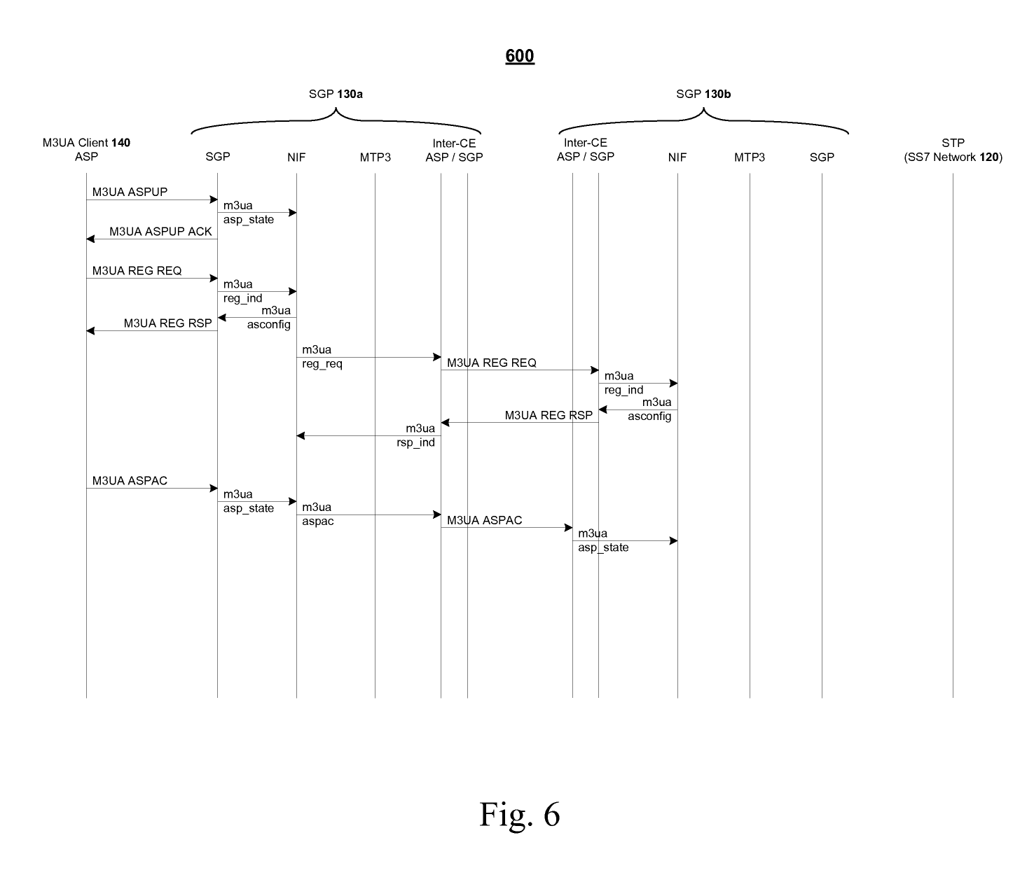

FIG. 6 illustrates a ladder diagram 600 depicting CIC registration for a particular application server process (e.g., a media gateway controller), according to an illustrative embodiment of the invention. The M3UA client 140's ASP sends a M3UA ASPUP message to the SGP stack instance of SGP 130a. The SGP stack instance calls a m3ua_asp_state function to indicate to the NIF the remote ASP's status. Based on the m3ua_asp_state function, the NIF looks up the remote ASP in its internal connection control information and marks it as UP. The SGP stack instance sends a M3UA ASPUP ACK message back to the M3UA client 140's ASP. Next, the M3UA client 140's ASP can send a M3UA REG REQ message to the SGP stack instance. The SGP stack instance calls m3ua_reg_ind function to indicate to the NIF the registration request from the ASP. The NIF calls into the stack with m3ua_asconfig to find out the routing key information for this application server and updates the local routing table with the current registration information. The routing key returned by m3ua_asconfig is parsed against that maintained in the remote application server entity of the NIF routing data. The NIF parses the routing key information in order to update its own routing table if necessary. The SGP stack instance sends a M3UA REG RSP message to the M3UA client 140's ASP. Since the registration is received at SGP 130a, further action is needed to register the key to its mated SGP 130b. The local application server configuration in the ASP towards the mate is updated with the m3ua_reg_req function, which sends a new dynamic registration to the mated SGP 130b. The inter-computer element (inter-CE) ASP stack instance of SGP 130a sends a M3UA REG REQ to the SGP stack instance of SGP 130b. SGP 130b's SGP stack instance calls m3ua_reg_ind function to indicate to its NIF the registration request from the ASP. The NIF parses routing key information in order to update its own routing table. As with SGP 130a, the SGP stack instance for SGP 130b calls m3ua_asconfig function and sends a M3UA REG RSP message back to the inter-CE ASP stack instance for SGP 130a. The inter-CE ASP stack instance calls the m3ua_rsp_ind function to indicate that a REG RSP has been received from the remote SGP. When the M3UA client 140's ASP enters into an active state, it will send an M3UA ASPAC message to the SGP stack instance of SGP 130a. The SGP stack instance calls a m3ua_asp_state function to indicate to the NIF the new remote ASP status. Based on the new status, the NIF looks up the remote AS using an identifier provided in the ASPAC message and changes the remote ASP state to be active. In this case, the direct connection (to M3UA client 140's ASP) is marked as active. Also, when the state of the remote ASP changes in the SGP, the NIF can change the state of its local AS in the ASP towards the mated SGP using the m3ua_aspac function. The inter-CE ASP stack instance of SGP 130a sends a M3UA ASPAC message to the inter-CE SGP stack instance of SGP 130b, which, in turns, calls a m3ua_asp_state function to indicate to the NIF the new remote ASP status. The NIF of SGP 130b looks up the remote AS using a provided identifier and changes the remote ASP state to be active, which, in this case, is the indirect connection to mated SGP 130a.

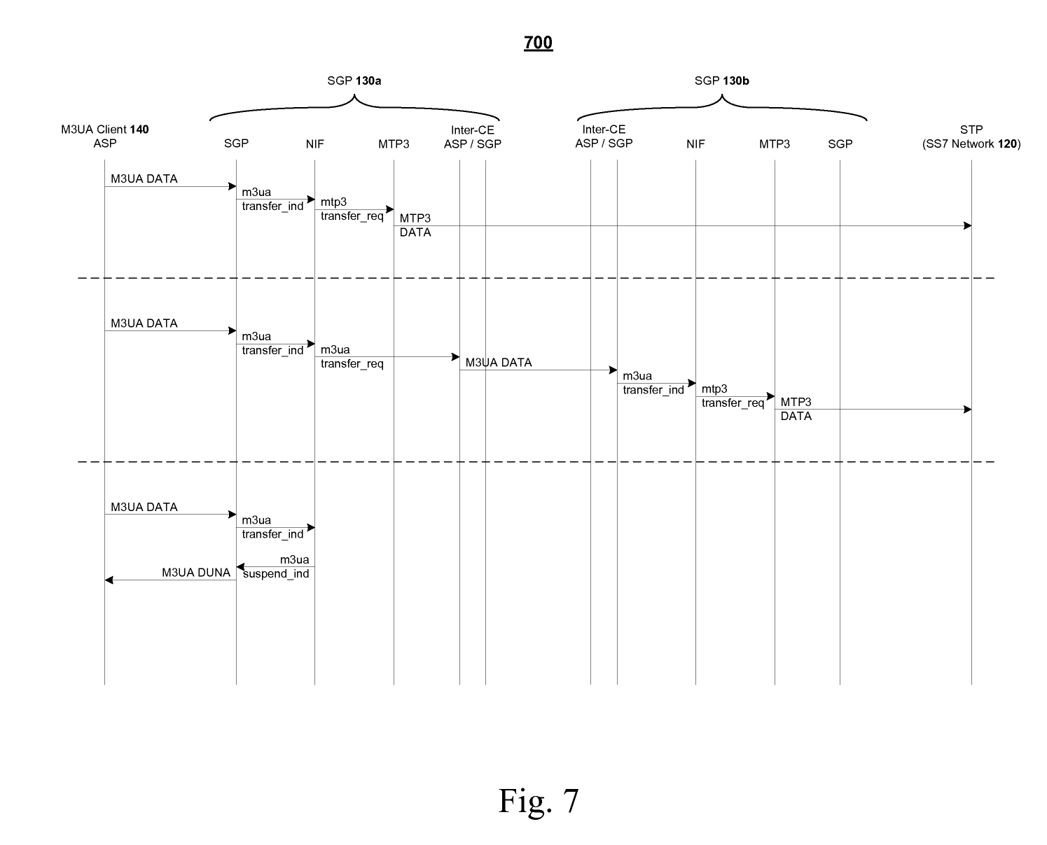

FIG. 7 illustrates a ladder diagram 700 depicting three scenarios for the transfer of signaling data from a M3UA client 140 to the signaling network 120, according to an illustrative embodiment of the invention. In each case, the M3UA client 140 sends a M3UA DATA message to the SGP stack instance of SGP 130a, which calls the NIF with the m3ua_transfer_ind function in order to pass control of the message to the NIF. The NIF interrogates its routing table to see if it has any direct remote STPs available on which to route the message. If it does, the NIF invokes the function call mtp3_transfer_req to send the MTP3 DATA message to the STP. If there is no direct STP available, then the NIF will forward the DATA message on to the mated SGP 130b, which, in turn, can attempt to send the MTP3 DATA message on an alternate route to the signaling network 120. In the case that there are no direct or indirect routes available, then the destination is unavailable and the NIF will call m3ua_suspend_ind function to send a M3UA DUNA message to the ASP of M3UA client 140.

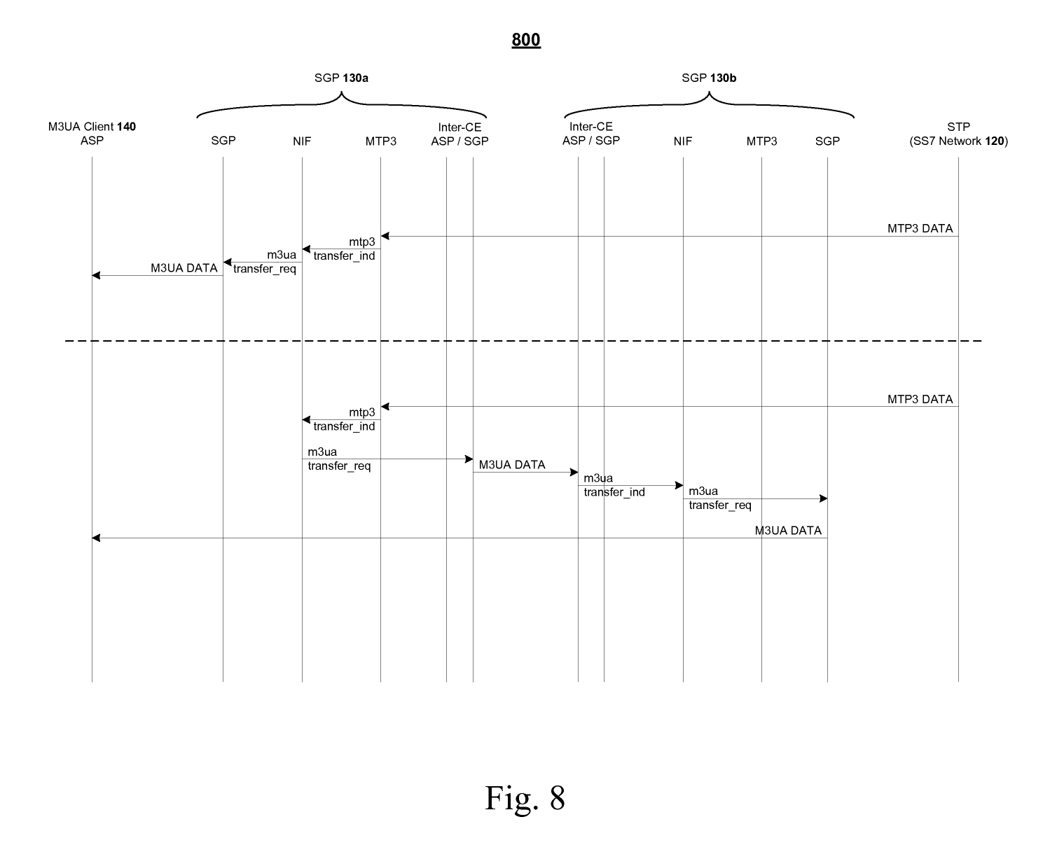

FIG. 8 illustrates a ladder diagram 800 depicting two scenarios for the transfer of signaling data from the signaling network 120 to a M3UA client 140, according to an illustrative embodiment of the invention. In each case, the MTP3 stack instance on the SGP 130a receives MTP3 DATA from the signaling network 120 and calls the NIF with the mtp3_transfer_ind function in order to pass control of the message to the NIF. The NIF interrogates its routing table to see if the M3UA client 140's remote ASP is directly available on which to route the message. If the route is available, then the NIF calls the m3ua_transfer_req function to send the M3UA DATA to the ASP of M3UA client 140. If there is no direct route to M3UA client 140's ASP, then there may be an indirect remote ASP available. In this case, the NIF of SGP 130a can forward the DATA message on this route which goes to its mated SGP 130b.

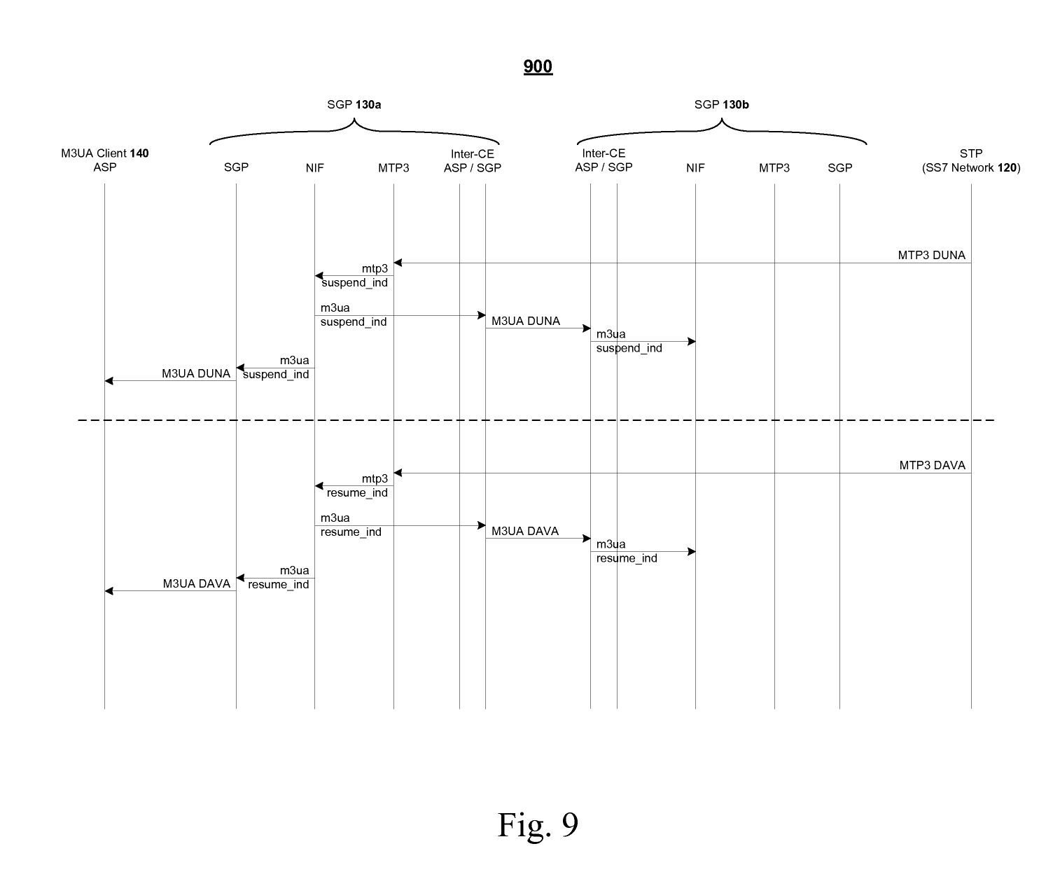

FIG. 9 illustrates a ladder diagram 900 depicting the processing of DUNA and DAVA SSNM messages, according to an illustrative embodiment of the invention. In each case, a MTP3 DUNA or DAVA message is received at the MTP3 stack instance of SGP 130a from the signaling network 120. For DUNA messages, the MTP3 stack calls the NIF with the mtp3_suspend_ind function. When the NIF receives the suspend indication from the signaling network 120, it looks up the affected DPC in its tables and marks the direct route as unavailable. For each DPC entry, there can also be an indirect route via the mated SGP 130b. The NIF calls the m3ua_suspend_ind function to the inter-CE SGP stack instance in order to send a DUNA to the inter-CE ASP stack instance in SGP 130b, which subsequently calls its NIF with m3ua_suspend_ind to update its routing control information. The NIF of SGP 130a can also forward the M3UA DUNA message to M3UA clients 140 via SGP 130a's SGP stack instance. When the NIF of SGP 130a receives the resume indication from the MTP3 stack instance, it looks up the affected DPC in its tables and marks the route (either direct or indirect as appropriate) as available. If the direct route has become available, the SGP 130a sends a DAVA message towards its SGP mate 130b using function m3ua_resume_ind. In addition, if there were previously no routes available, the NIF can send a DAVA message towards a M3UA client 140 using function m3ua_resume_ind.

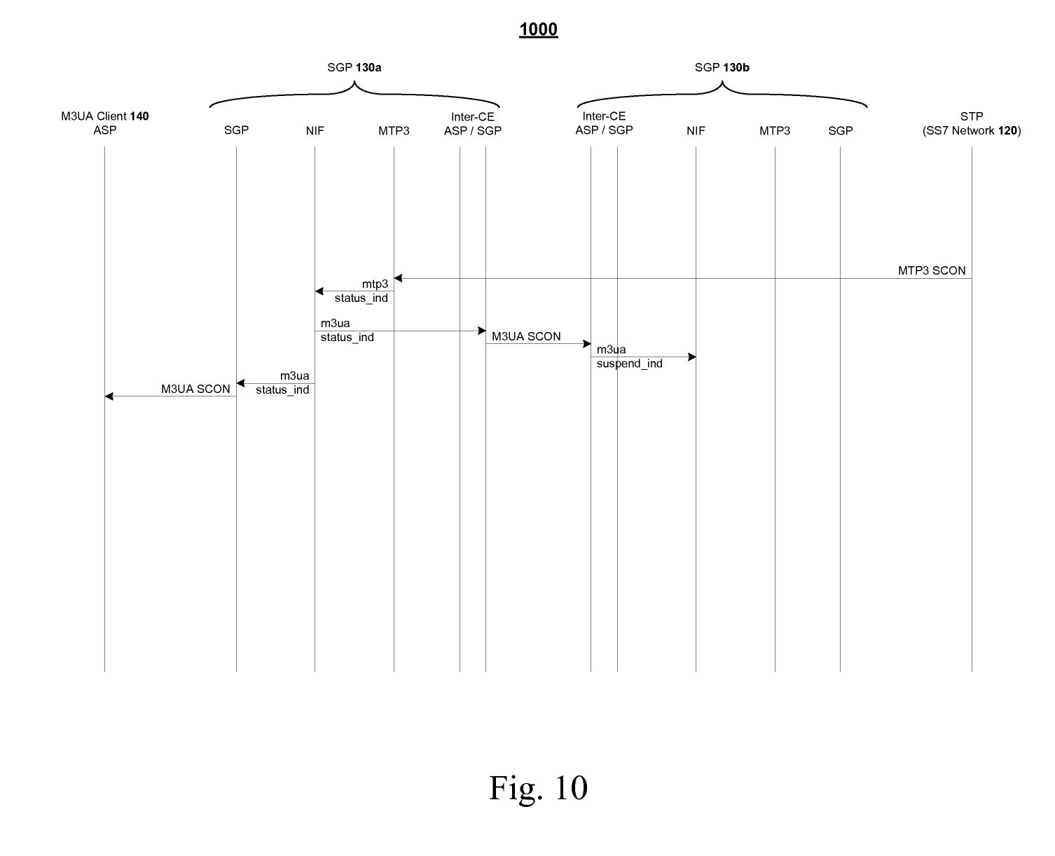

FIG. 10 illustrates a ladder diagram 1000 depicting the processing of SCON SSNM messages, according to an illustrative embodiment of the invention. A MTP3 SCON message is received at the MTP3 stack instance of SGP 130a from the signaling network 120. The MTP3 stack calls the mtp3_status_ind function and includes information of network congestion in the signaling network 120. The NIF looks up the DPC and can mark the route (direct in this example) with the congestion level received. Since the SCON message was received from the signaling network 120, a matching M3UA SCON message is sent to the mated SGP 130b using the function m3ua_status_ind. The mated SGP's NIF will similarly update and mark the indicated route (indirect in this case) with the congestion level received. The NIF of SGP 130a can use the lower of its congestion statuses for all routes as the congestion status presented to the a M3UA client 140's ASP. In this case, that status has changed so a M3UA SCON is transmitted to the ASP of M3UA client 140.

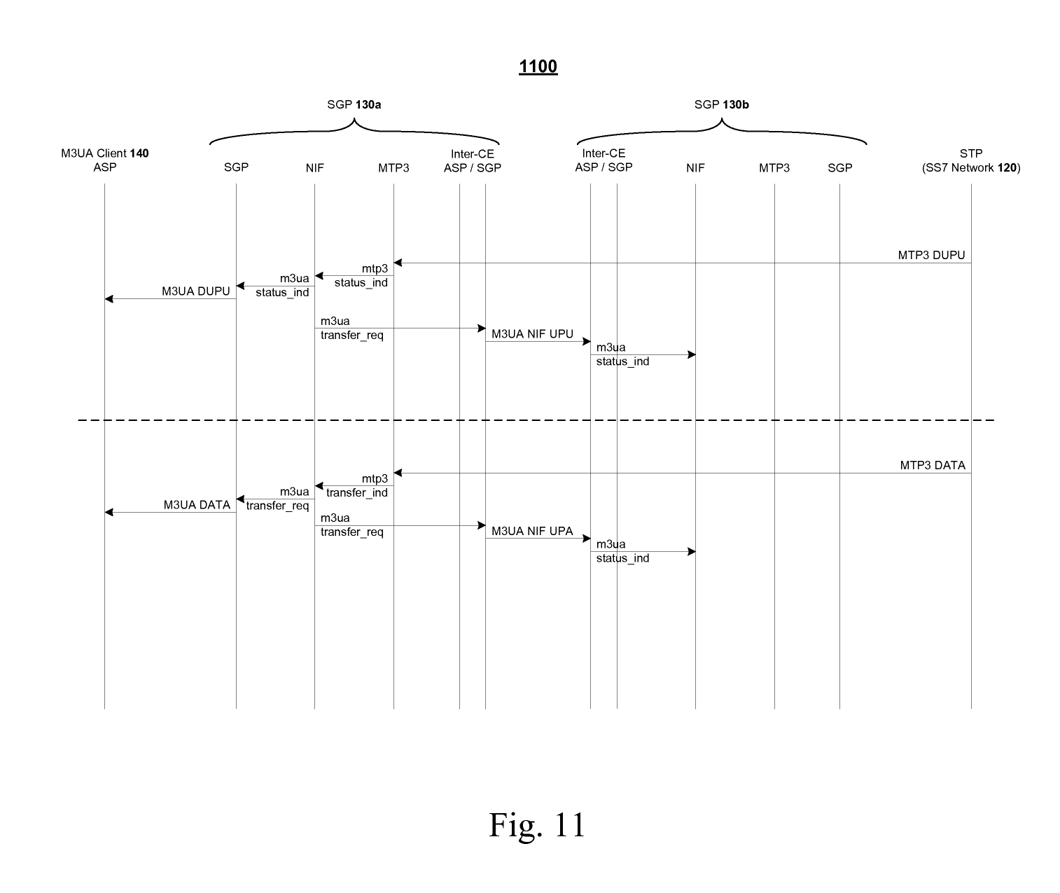

FIG. 11 illustrates a ladder diagram 1100 depicting processing of DUPU SSNM messages, according to an illustrative embodiment of the invention. A MTP3 DUPU message is received at the MTP3 stack instance of SGP 130a from the signaling network 120. The MTP3 stack calls the mtp3_status_ind function to forward the relevant status indication to the NIF. The NIF, in turn, can use the list of remote application servers to broadcast the DUPU message to all affected M3UA clients 140 (e.g., all those registered in the node associated with the local application server on which the DUPU was received) using the m3ua_status_ind function. If an affected remote application server does not have an active and direct ASP, then action does not have to be taken, but the mated SGP 130b can still take action. The NIF can mark the destination as unavailable for the affected user part. To indicate to the mated SGP 130b that the user part is unavailable a M3UA NIF UPU message can be used. The function m3ua_transfer_request can be used to send the message, which can have the same format as a M3UA DUNA message but with a different tag. When the mate SGP 130b receives the new message, it can mark the destination in its routing control information with the unavailable user part and can send DUPU to all its affected remote application servers. Subsequently, when any transfer DATA message is received at the NIF from a previously marked unavailable user part on the signaling network 120, then the message can be forwarded to the appropriate remote AS as normal and the user part unavailable status can be cleared from the destination in both the local and mated SGP. To clear the status from the mated SGP, a M3UA NIF UPA message can be used, which can have the same format as a M3UA DUNA message but with a different tag.

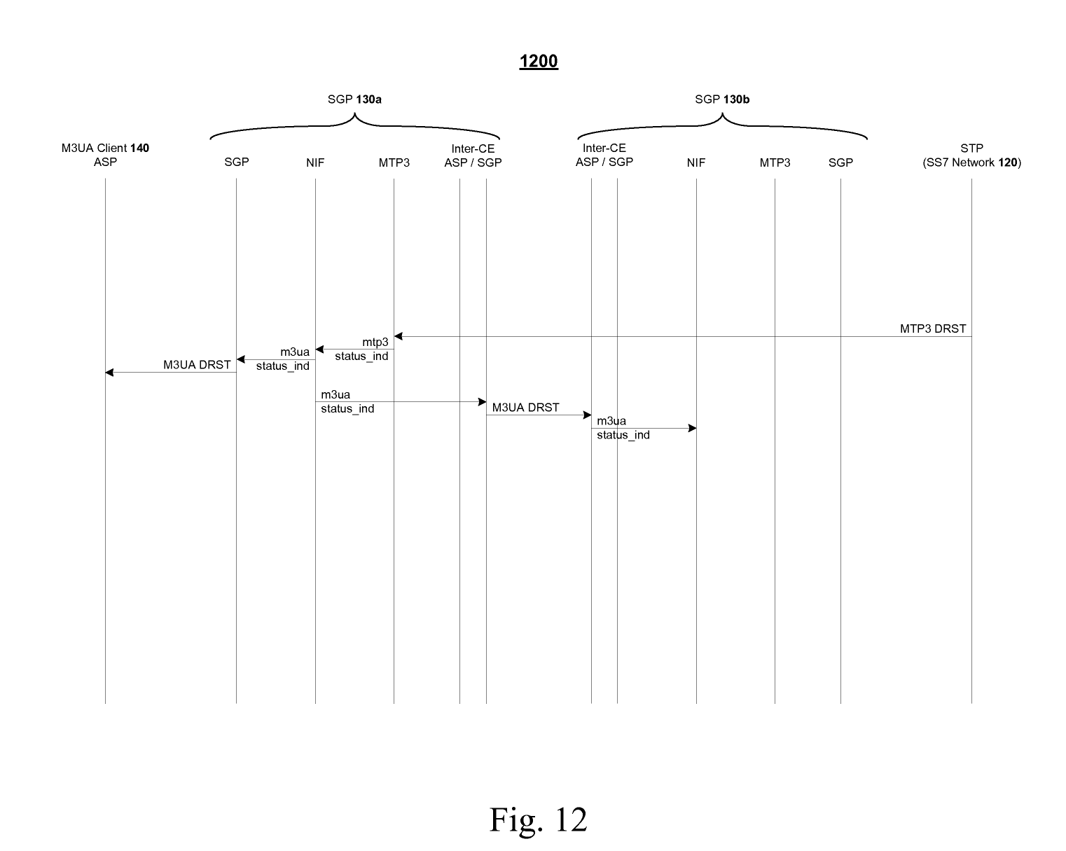

FIG. 12 illustrates a ladder diagram 1200 depicting processing of DRST SSNM messages, according to an illustrative embodiment of the invention. A MTP3 DRST message is received at the MTP3 stack instance of SGP 130a from the signaling network 120. The MTP3 stack calls the mtp3_status_ind function to forward the relevant status indication to the NIF. The NIF, in turn, can look up the affected DPC in its routing control information (e.g., tables) and mark the direct route as having received DRST (i.e., it is restricted). For each DPC entry there can also be an indirect route. Using the m3ua_status_ind function, the NIF can send a M3UA DRST message on the inter-CE SGP stack instance of SGP 130a to the inter-CE ASP stack instance of mated SGP 130b. The mated SGP 130b can update its routing control information tables accordingly. For example, when the mated SGP's NIF receives the status indication, it can look up the affected DPC in its tables and mark the indirect route as restricted having received the DRST message.

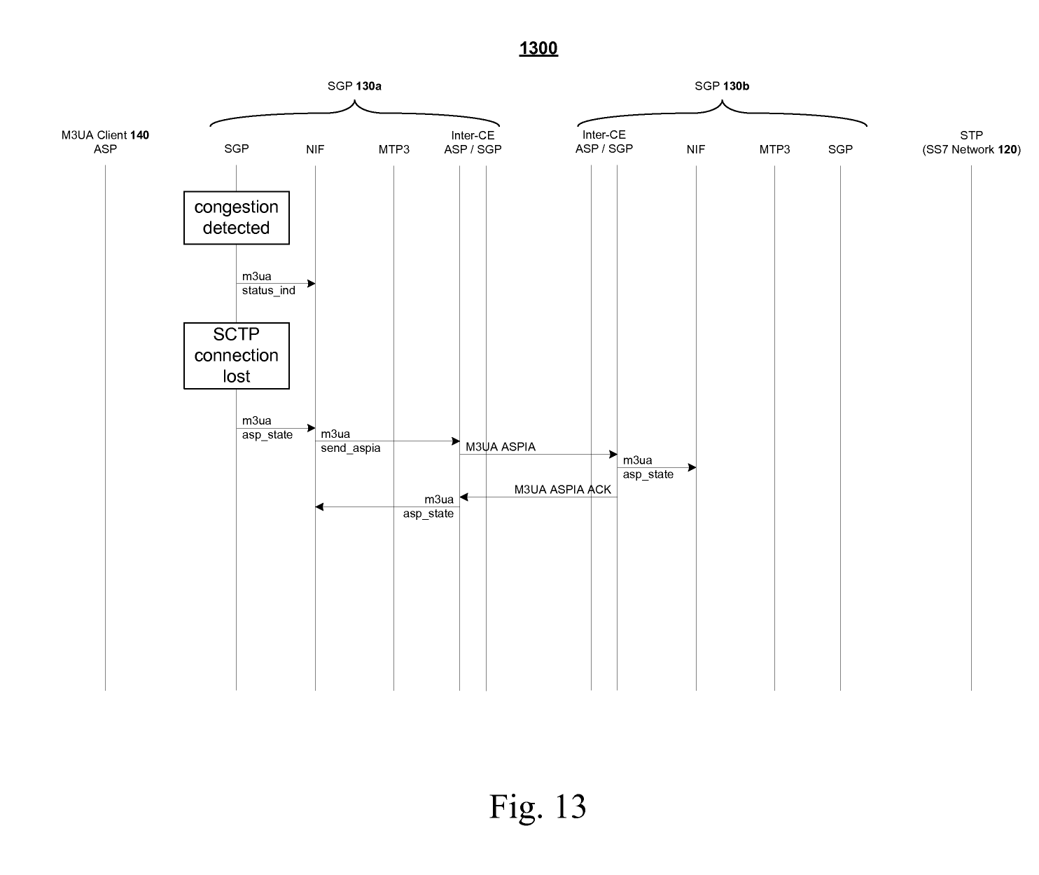

FIG. 13 illustrates a ladder diagram 1300 depicting SCTP failure on the IP network 120, according to an illustrative embodiment of the invention. When local congestion is detected at the SGP stack instance of SGP 130a when it is trying to transmit a message, the SGP stack calls the m3ua_status_ind function to indicate to the NIF the congestion status. The NIF can find the affected remote application server and store the congestion level. When the SCTP connection is lost, the remote ASP state of M3UA client 140 can change to “down” status globally (no AS is specified). The NIF can go through the list of application servers associated with the affected ASP and mark them as down (i.e., they are no longer available to route messages). For each remote application server, the ASP stack instance on SGP 130a for the local AS towards the mated SGP 130b can be marked as inactive so that the mate does not send any more messages for this particular application server. Function m3ua_send_aspia can be issued to send the M3UA ASPIA message to the mated SGP 130b.

FIGS. 6-13 can equally be applied to SUA messages from and/or to ASPs on SUA clients 150. In addition to essentially replacing M3UA with SUA, an additional SCCP layer is present on the stack instance facing the signaling network 120. Specifically, the SCCP layer is interfaced between the SUA NIF and the MTP3 or M3UA layer (see FIG. 5).

Different versions of SCTP are defined by Request for Comments (RFCs) 2960, 3873, 4166 and 4960, each of which are incorporated herein in their entirety by reference. M2PA is defined by RFC 4165, which is incorporated in their entirety by reference. Different versions of M3UA are defined by RFC 3332 and 4666, each of which is incorporated herein in their entirety by reference. SUA is defined by RFC 3868, which is incorporated herein in their entirety by reference. One of skill in the art will appreciate that the above-described techniques can also be applied to future versions of SCTP, M2PA, M3UA and/or SUA.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and the computer program can be deployed in any form, including as a stand-alone program or as a subroutine, element, or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by, and an apparatus can be implemented as, special purpose logic circuitry, e.g., an FPGA (field programmable gate array) or an ASIC (application-specific integrated circuit). Subroutines can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD, DVD, and HD-DVD disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computer-implemented method for implementing signaling gateway redundancy, the computer-implemented method comprising:
receiving, at a first signaling gateway host, a first Signaling Transport (SIGTRAN) protocol application server process maintenance message from a first application server process;
updating connection control information associated with one or more connections to the first signaling gateway host based on the first SIGTRAN protocol application server process maintenance message; and
transmitting, from the first signaling gateway host, a second SIGTRAN protocol application server process maintenance message to a second signaling gateway host, the second SIGTRAN protocol application server process maintenance message based on the first SIGTRAN protocol application server process maintenance message, the second signaling gateway host being mated with the first signaling gateway host.

2. The computer-implemented method of claim 1, wherein the first SIGTRAN protocol application server process maintenance message comprises an Application Server Process Traffic Maintenance (ASPTM) message.

3. The computer-implemented method of claim 2, wherein the ASPTM message comprises an ASP Active (ASPAC) message, a ASP Inactive (ASPIA) message, or any combination thereof.

4. The computer-implemented method of claim 1, wherein the first SIGTRAN protocol application server process maintenance message comprises an Application Server Process State Maintenance (ASPSM) message.

5. The computer-implemented method of claim 4, wherein the ASPSM message comprises an ASP Up (ASPUP) message, a ASP Down (ASPDN) message, a Heartbeat (BEAT) message, or any combination thereof.

6. The computer-implemented method of claim 1, wherein the first SIGTRAN protocol application server process maintenance message comprises a Routing Key Management (RKM) message.

7. The computer-implemented method of claim 6, wherein the RKM message comprises a Registration Request (REG REQ) message, a Deregistration Request (DEREG REQ) message, or any combination thereof.

8. The computer-implemented method of claim 1, wherein the first and second SIGTRAN protocol application server process maintenance messages are based on a MTP3 User Adaption (M3UA) protocol, a SCCP User Adaption (SUA) protocol, or any combination thereof.

9. The computer-implemented method of claim 8, wherein the second SIGTRAN protocol application server process maintenance messages is transmitted to the second signaling gateway host using a ASP-SGP SCTP association between the first and second signaling gateway hosts.

10. The computer-implemented method of claim 1, wherein the connection control information comprises state information for one or more application servers and/or one or more application server processes.

11. The computer-implemented method of claim 1, further comprising:
receiving, at the first signaling gateway host, a third SIGTRAN protocol application server process maintenance message from the second signaling gateway host; and
updating the connection control information associated with the first signaling gateway host based on the third SIGTRAN protocol application server process maintenance message.

12. The computer-implemented method of claim 1 further comprising:
determining whether a state of an SCTP association between the first signaling gateway host and the first application server process has changed;
if it is determined that the state of the SCTP association has changed, then:
updating connection control information associated with the SCTP association based on the change in the state of the SCTP association; and
transmitting, from the first signaling gateway host, a third SIGTRAN protocol application server process maintenance message to the second signaling gateway host, the third SIGTRAN protocol application server process maintenance message based on the change in the state of the SCTP association.

13. The computer-implemented method of claim 12, wherein the state of the SCTP association comprises an up state, a down state, a congestion state, or any combination thereof.

14. The computer-implemented method of claim 1, wherein the connection control information comprises state information for one or more signaling end points on an Internet Protocol (IP) network.

15. The computer-implemented method of claim 14, wherein the state information for the one or more signaling end points are grouped by application server identifiers, application server process identifiers, or any combination thereof.

16. A computer program product, tangibly embodied in a machine-readable storage device, the computer program product including instructions being operable to cause a data processing apparatus to:
receive, at a first signaling gateway host, a first Signaling Transport (SIGTRAN) protocol application server process maintenance message from a first application server process;
update connection control information associated with one or more connections to the first signaling gateway host based on the first SIGTRAN protocol application server process maintenance message; and
transmit, from the first signaling gateway host, a second SIGTRAN protocol application server process maintenance message to a second signaling gateway host, the second SIGTRAN protocol application server process maintenance message based on the first SIGTRAN protocol application server process maintenance message, the second signaling gateway host being mated with the first signaling gateway host.

17. A system for implementing signaling gateway redundancy, the system comprising:
a controller configured to:
receive, at a first signaling gateway host, a first Signaling Transport (SIGTRAN) protocol application server process maintenance message from a first application server process;
update connection control information associated with one or more connections to the first signaling gateway host based on the first SIGTRAN protocol application server process maintenance message; and
transmit, from the first signaling gateway host, a second SIGTRAN protocol application server process maintenance message to a second signaling gateway host, the second SIGTRAN protocol application server process maintenance message based on the first SIGTRAN protocol application server process maintenance message, the second signaling gateway host being mated with the first signaling gateway host.

18. A system for implementing signaling gateway redundancy, the system comprising:
means for receiving, at a first signaling gateway host, a first Signaling Transport (SIGTRAN) protocol application server process maintenance message from a first application server process;
means for updating connection control information associated with one or more connections to the first signaling gateway host based on the first SIGTRAN protocol application server process maintenance message; and
means for transmitting, from the first signaling gateway host, a second SIGTRAN protocol application server process maintenance message to a second signaling gateway host, the second SIGTRAN protocol application server process maintenance message based on the first SIGTRAN protocol application server process maintenance message, the second signaling gateway host being mated with the first signaling gateway host.
